(19) United States
(12) Patent Application Publication
(10) Pub. No.: US 2004/0103188 A1
(43) Pub. Date: May 27, 2004

(54) Method, system, and mechanism for providing diagnostics in an interconnected network of gateways and servers

(76) Inventors: James W. Pickel, Gilroy, CA (US); Christopher J. Crone, San Jose, CA (US)

Correspondence Address: Richman and Associates, PO Box 3333, La Jolla, CA, 92038-3333, US

(21) Appl. No.: 10/303,105

(22) Filed: Nov. 22, 2002

(51) Int. Cl. G06F 15/173

(52) U.S. Cl. 709/224

(57) ABSTRACT

A method, system, or mechanism for providing diagnostic information for a data request in a distributed data system where the distributed data system includes a plurality of interconnected data request processing devices and where only the one data request processing device of the plurality of interconnected data request processing devices that fulfills the data request appends request fulfillment diagnostic information to the fulfilled data request, each interconnected data request processing devices that participates in the processing of the data request appends data request processing device condition information diagnostics to the data request, and each data request processing device that forms a connection between another data request processing device while processing the data request appends connection information diagnostics to the fulfilled data request related to the connection between the data request processing device and the another data request processing device.

### BACKGROUND OF THE INVENTION

1. Field of the Invention

This invention relates to providing diagnostic information for server requests, and more particularly to providing diagnostic information for server requests processed in an interconnected network of gateways and servers.

2. Description of Related Art

In distributed data systems a data request may be executed on multiple systems. It is desirable to be able to generate or provide complete diagnostic information about a data request as it is processed at each system. A diagnostic information request (for a data request) may require the execution of a new request in the distributed data system. Further, the diagnostic information provided by the system may include redundant information and exclude relevant connection data. Thus, a need exists for a method, system, and mechanism that generates/provides data request diagnostic information that includes relevant connection data while eliminating redundant information.

### SUMMARY OF THE INVENTION

The present invention is a method, system, or mechanism for providing diagnostic information for a data request in a distributed data system. The distributed data system includes a plurality of interconnected data request processing devices. In the invention, a one data request processing device of the plurality of interconnected data request processing devices fulfills the data request. Then, only the one data request processing device appends request fulfillment diagnostic information to the fulfilled data request.

In the invention each interconnected data request processing devices that participates in the processing of the data request may append data request processing device condition information diagnostics to the data request. Further, in the invention another data request processing device may forward the data request to the one data request processing device. The another data request processing device also appends data request processing device condition information diagnostics to the data request.

In addition, in the invention another data request processing device may receive the fulfilled data request from the one data request processing device. In this case, the another data request processing device may append connection information diagnostics to the fulfilled data request related to the connection between the another data request processing device and the one data request processing device. To this end, in another case each data request processing device that forms a connection between another data request processing device while processing the data request may append connection information diagnostics to the fulfilled data request related to the connection between the data request processing device and the another data request processing device.

In another embodiment one data request processing device may append a data request processing device condition information diagnostics array to the data request. The one data request processing device may further append a data request processing device connection information diagnostics array to the data request. In this embodiment, each data request processing device that participates in the processing of the data request may insert data request processing device condition information diagnostics into a row of the condition information diagnostics array.

When another data request processing device forwards the data request to the one data request processing device, the another data request processing device may insert data request processing device condition information diagnostics into a row of the condition information diagnostics array for the another data request processing device. In addition, when the another data request processing device receives the fulfilled data request from the one data request processing device, the another data request processing device may insert connection information diagnostics into a row of the connection information diagnostics array. In this embodiment, the connection information diagnostics is related to the connection between the another data request processing device and the one data request processing device.

In the invention each data request processing device that forms a connection between another data request processing device while processing the data request may insert connection information diagnostics into a row of the connection information diagnostics array. In this case, the connection information diagnostics is related to the connection between the data request processing device and the another data request processing device. In one embodiment one of the plurality of interconnected data request processing devices is a database server or a gateway. In this embodiment the data request may be a SQL request.

### BRIEF DESCRIPTION OF THE DRAWINGS

FIG. 1 is a diagram of an exemplary distributed database system where the apparatus and method of the present invention may be employed.

FIG. 2 is a diagram of an exemplary requested data object with diagnostic information objects according to an embodiment of the present invention.

FIG. 3 is a block diagram of an exemplary apparatus according to an embodiment of the present invention.

FIGS. 4 to 7 are flow diagrams of exemplary methods to be executed at a database server/gateway according to an embodiment of the present invention.

FIGS. 8 to 9 are flow diagrams of exemplary methods to be executed at a client according to an embodiment of the present invention.

Like reference numbers and designations in the various drawings indicate like elements.

### DETAILED DESCRIPTION OF THE PREFERRED EMBODIMENTS

Throughout this description, the preferred embodiment and examples shown should be considered as exemplars, rather than as limitations on the present invention.

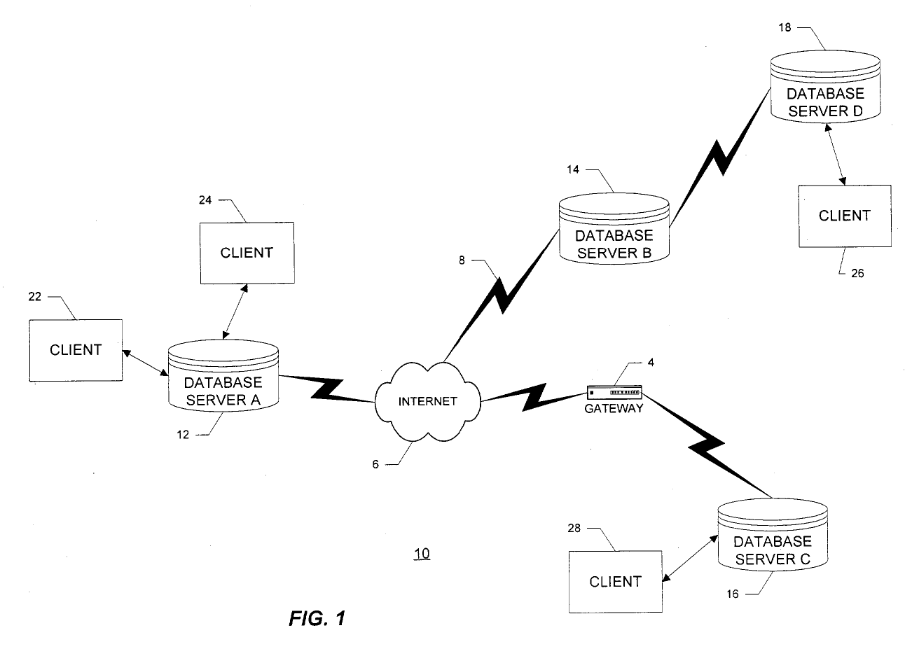

FIG. 1 is a diagram of an exemplary distributed database system 10 in which the present may be employed. The database system 10 includes a plurality of database servers (A, B, C, and D) 12, 14, 16, and 18, a gateway 4, and at least one client 22. In this system 10, clients 22, 24, 26, and 28 are coupled to database servers (22, 24 to A 12, 26 to D 18, and 28 to C 16). Database server A is coupled to a network of networks (Internet) 6. Gateway 4 is coupled the Internet 6 and database server C 16. Database server B 14 is coupled to the Internet 6 and database server D 18. FIG. 3 depicts an apparatus 40 in accordance with the present invention where the apparatus may be employed as a database server (A, B, C, or D) 12, 14, 16, and 18, a gateway 4, or client 22, 24, 26, or 28. The apparatus 40 includes a processor 42, a storage unit 46, and a communications device 44. The processor 42 may be any suitable microprocessor that may be used to perform applications employed by a client, database server, or gateway (such SQL applications). The storage unit 46 may be any known storage unit such as hard drive, floppy drive, CDROM, DVDROM, and optical drive. The storage unit 46 may be used to store a database and program instructions for performing applications. The communications device 44 may be any device enabling the apparatus 40 to communicate data, such as data requests and requested data, to clients, database servers, Internet, or gateway.

In system 10, a client (22, 24, 26, or 28) application may couple to a database server (A, B, C, or D) 12, 14, 16, or 18 to request data located on one or more of the database servers. For example, a client 22 application coupled to database server A may be a SQL application that generates a SQL request for data located in a database of the system 10. Database server A 12 receives and processes the SQL request and may forward the data request to database server B or gateway 4 when the requested data is not stored locally (in a storage unit 46). For example, when the requested data is maintained by database server D, client 22 application's data request may hop (be forwarded or prorogate) from database server A to database server B 14 (via Internet 6 and connection 8) and then hop to database server D 18. An application (running in a processor 42) of the database server D 18 may process the SQL data request and forward the requested data back to the requesting application (client 22 SQL application) via database server B 14, internet 6, and database server A 12.

A client application may also request diagnostic information for a data request. In an exemplary embodiment of the present invention, a client application sets a diagnostic flag or indicator. When the diagnostic flag or indicator is set for a client application, the present invention includes diagnostic information with all data requests from the client application. In one embodiment, the data request may include a diagnostic information desired indicator (such as a data bit). In this embodiment, a database server application evaluates diagnostic information desired indicator of a received data request to determine whether to include diagnostic information with the requested data (when the request is completed).

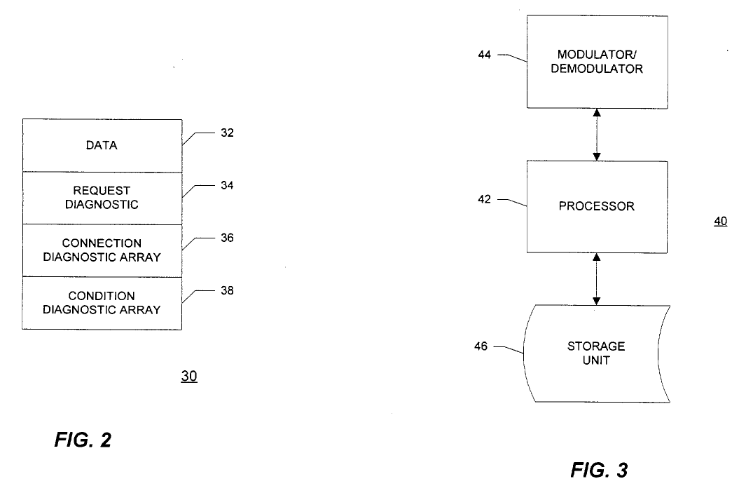

In an exemplary embodiment of the invention, diagnostic information includes request, connection, and condition diagnostic information. In this embodiment when a client application executes a data request with diagnostics activated (indicator set in one embodiment), the returned requested data (requested data object in one embodiment) includes request, connection, and condition diagnostic information. FIG. 2 is a diagram of an exemplary requested data package 30 with diagnostic information according to an exemplary embodiment of the invention. The data package includes a data object 32, a request statement diagnostic object 34, a connection diagnostic array object 36, and a condition diagnostic array object 38.

The data object 32 (or packet) includes the requested data, e.g., a tuple or set of records from a database. In one embodiment, the request statement diagnostic object 34 includes diagnostic information related to the request, e.g., the numbers of rows or columns of data included in the data object 32. In an exemplary embodiment, the request statement diagnostic object 34 is generated/created by the database server(s) that fulfilled the request (supply the requested data). In one distributed data system the requested data may be segmented among several database servers. In this embodiment, each database server providing a segment of the requested data may generate a request statement diagnostic object 34 (for their respective data segment).

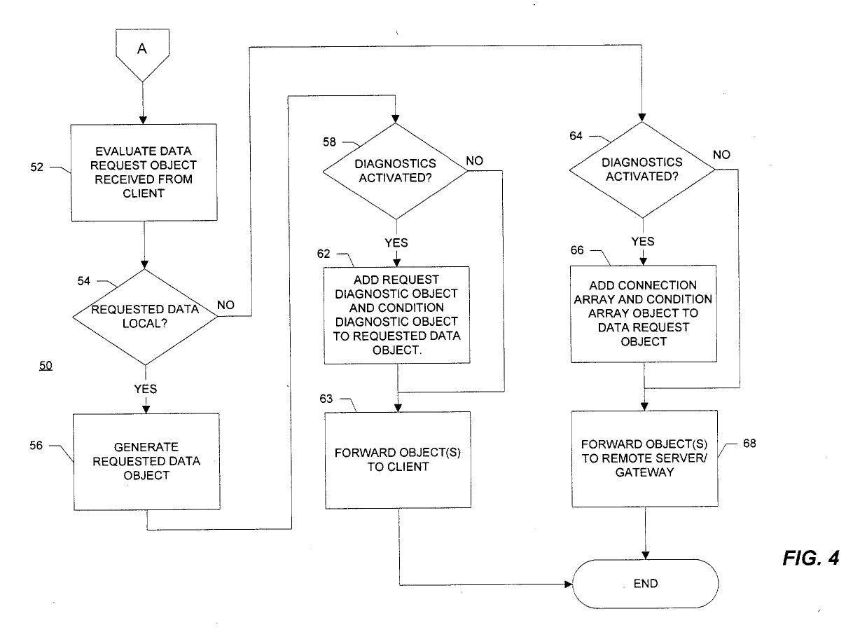

The connection diagnostic array object 36 includes an array entry for each database server/gateway that participated in the execution of the data request including the forwarding/return of the data request to the database server(s) that fulfilled the data request. Each entry may contain information about the server/gateway, e.g., the server release level or server functional level. The condition diagnostic array object 38 may include a condition array entry for each server/gateway that participated in the execution of the data request. The condition information may include warning and error conditions that were generated/existed during the execution of the data request. In an exemplary embodiment, the returned data package 30 includes only one request diagnostic object 34 and only one connection diagnostic object 36. The data package 30 may include multiple condition diagnostic array objects 38. FIGS. 4 to 7 are flow diagrams of exemplary methods to be executed at a database server/gateway according to an embodiment of the present invention to process data requested and requested data.

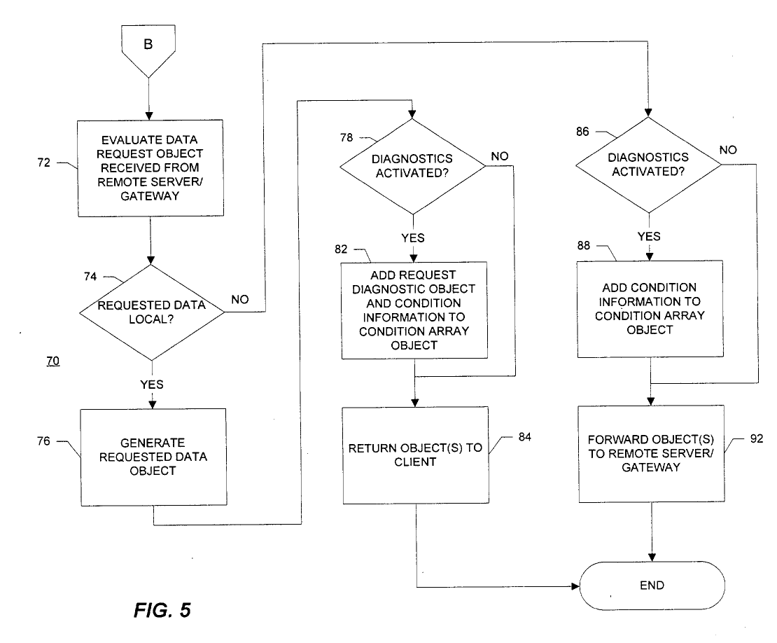

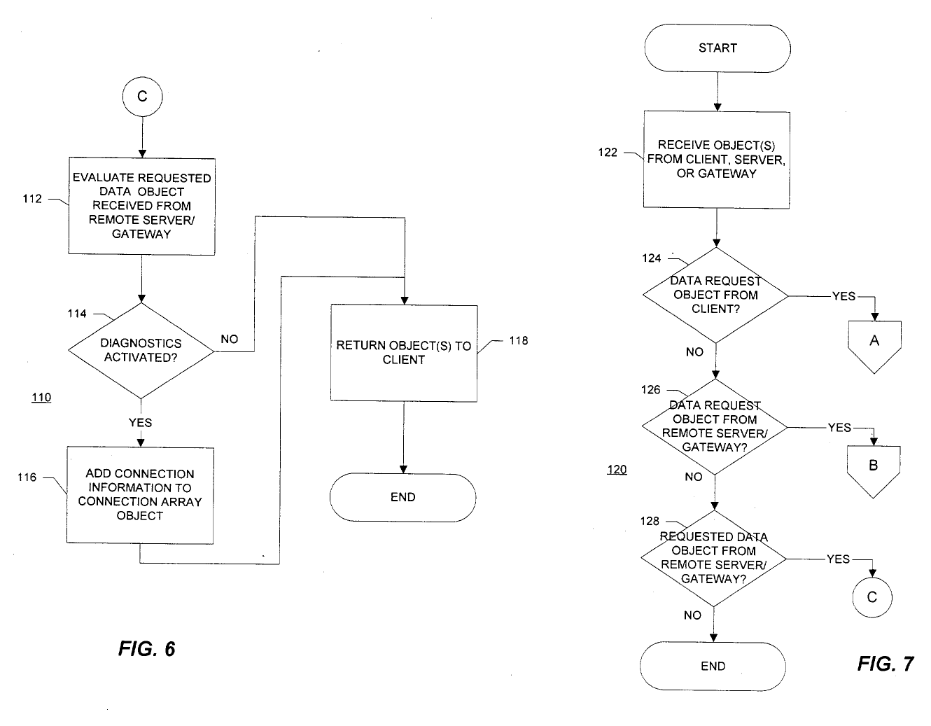

FIG. 7 is a flow diagram of a method 120 for processing an object received at a database server or gateway from a client, database server, or gateway application in accordance with the present invention. At step 122 of method 120 a database server or gateway application receives an object from another database server or gateway application or client application. Steps 124, 126, and 128 determine whether the received object is a data request from a client application (step 124), a data request object from another database server or gateway application (step 126), or is a requested data object from another database server or gateway application (step 128). When the received object is a data request object from a client application coupled to a database server or gateway performing method 120, control is passed to method 50 (shown in FIG. 4) (step 124). When the received object is a data request object forwarded from another database server or gateway application, control is passed to method 70 (shown in FIG. 5) (step 126). When the received object is a requested data object forwarded from another database server or gateway application, control is passed to method 110 (shown in FIG. 6) (step 128).

When a data request object from a client application coupled to a database server or gateway is received, the database server or gateway application invokes method 50 of FIG. 4 in one embodiment of the present invention. The method 50 evaluates the data request object (step 52) and determines whether the requested data (or at least a segment) is local (step 54), i.e., stored in database coupled directly to the database server (performing method 50). When the requested data is local, the database server application generates the requested data object (step 56) and adds a request diagnostic object and a condition diagnostic object to the requested data object (step 62) when diagnostics are activated (step 58).

The request diagnostic object may include information related to the fulfilled data request. The condition diagnostic object may have a single array including any warning or errors generated while fulfilling the data request. Diagnostics may be activated for a particular client or for all requests to the database server. In one embodiment, the data request object may include a diagnostic activation indication. Then regardless of diagnostic activation, the requested data object (such as one or more rows/columns) is forwarded to the requesting client application. When diagnostics are activated, a connection diagnostic object is not included since no connection (other than the local connection between the client application and database server application) was required to complete the data request.

When the requested data is not local (step 54), the data request object is forwarded to an appropriate gateway or database server application (step 68). In one embodiment, the method 50 adds an empty connection array object and an empty condition array object (step 66) to the data request prior to forwarding the objects (step 68) when diagnostics are activated (step 64). In this embodiment the present of these objects with the data request object may be an indication that diagnostic are active (for downstream database servers or gateways).

When a data request object from a database server or gateway application coupled to a database server or gateway is received, the database server or gateway application invokes method 70 of FIG. 5 in one embodiment of the present invention. The method 70 evaluates the data request object (step 72) and determines whether the requested data (or at least a segment) is local (step 74), i.e., stored in a database coupled directly to the database server (performing method 70). When the requested data is local, the database server application generates the requested data object (step 76) and adds or appends a request diagnostic object and condition information (if any) to an array of the condition diagnostic object to the requested data object (step 82) when diagnostics are activated (step 78).

As before, the request diagnostic object may include information related to the fulfilled data request. The condition diagnostic object may have an array including any warning or errors generated while fulfilling the data request. In one embodiment, a database server or gateway application may determine that diagnostics are activated when a connection diagnostic object and condition diagnostic object is coupled with the received data request object. Then the requested data object (such as one or more rows/columns) is forwarded to the requesting client application (along with the diagnostic objects when active) (step 84). When the requested data is not local (step 74), the data request object is forwarded to an appropriate gateway or database server application (step 92). In one embodiment, the method 70 adds or appends condition information to an array of the condition diagnostic object (step 88) prior to forwarding the objects (step 92) when diagnostics are activated (step 86).

When a requested data object (fulfilled data request) from a database server or gateway application coupled to a database server or gateway is received, the database server or gateway application invokes method 110 of FIG. 6 in one embodiment of the present invention. The method 110 evaluates the requested data object (step 112) and forwards the requested data object to the client via an appropriate gateway or database server application (step 118) (in one embodiment to the requesting database server or gateway). When diagnostics are activated (step 114), the method 110 adds or appends connection information to an array of the connection diagnostic object (step 116) prior to forwarding the objects (step 118). The connection information relates the connection between the database server and gateway application that forwarded the requested data object to database server or gateway application performing method 110.

In the invention, a user application may generate a data request and forward the data request to a client application (22, 24, 26, or 28) where the user application is coupled to the user application. FIG. 8 is a flow diagram of an exemplary method 130 that a client application may execute to process a user application data request. In method 130 at step 132 a client receives a user application data request and generates a data request object. Then when diagnostics are activated (step 134), the client application may generate a local diagnostic object and add condition and connection information to the local diagnostic object (step 136). In one embodiment the user application data request may include a diagnostic activation indicator that the method 130 evaluates to determine whether diagnostics are active. Then the method 130 forwarded to the data request object to an appropriate server or gateway (step 138).

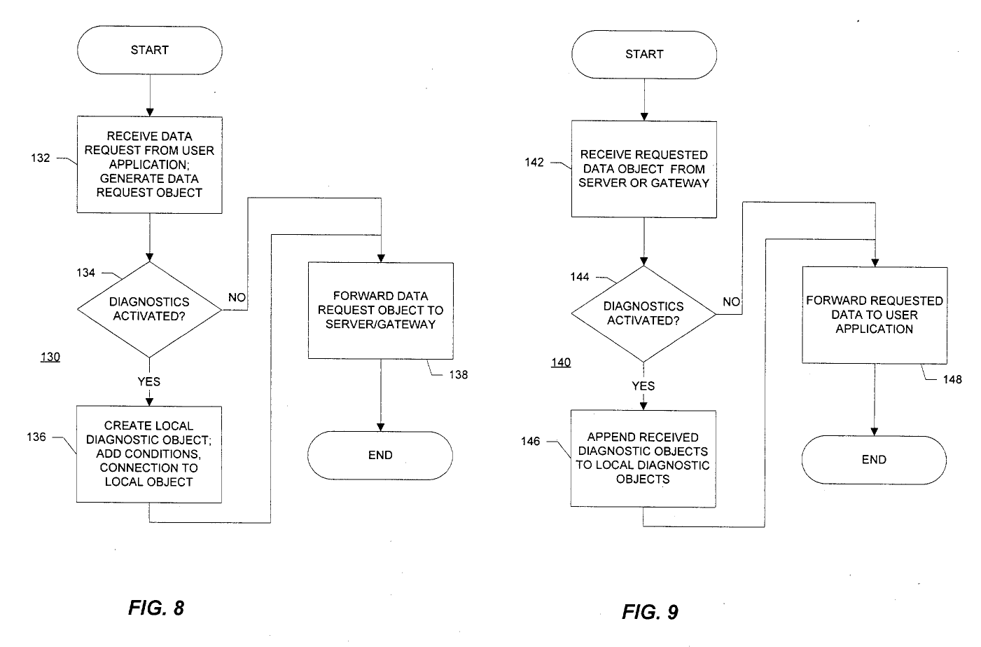

FIG. 9 is a flow diagram of an exemplary method 140 that a client application may execute to process a completed data request received from a gateway or server (step 142). When diagnostics are activated (step 144), the received, completed data object includes diagnostics objects from servers/gateways that participated in the fulfillment of the data request. The method appends these diagnostic objects to its local diagnostic objects (step 146) and forwards the requested data (with diagnostics when active) to the user application (step 148).

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware (e.g., a software language other than Java, such as C++ or others may be used to implement the invention). As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. A method of providing diagnostic information for a data request in a distributed data system including a plurality of interconnected data request processing devices, comprising the steps of:
a) a one data request processing device of the plurality of interconnected data request processing devices fulfilling the data request; and
b) only the one data request processing device of the plurality of interconnected data request processing devices appending request fulfillment diagnostic information to the fulfilled data request.

2. The method of providing diagnostic information for a data request in a distributed data system including a plurality of interconnected data request processing devices of claim 1, further comprising the step each of the plurality of interconnected data request processing devices that participate in the processing of the data request appending data request processing device condition information diagnostics to the data request.

3. The method of providing diagnostic information for a data request in a distributed data system including a plurality of interconnected data request processing devices of claim 1, further comprising the steps of:
c) another data request processing device of the plurality of interconnected data request processing devices forwarding the data request to the one data request processing device; and
d) the another data request processing device appending data request processing device condition information diagnostics to the data request.

4. The method of providing diagnostic information for a data request in a distributed data system including a plurality of interconnected data request processing devices of claim 3, further comprising the steps of:
e) the another data request processing device of the plurality of interconnected data request processing devices receiving the fulfilled data request from the one data request processing device; and
f) the another data request processing device appending connection information diagnostics to the fulfilled data request related to the connection between the another data request processing device and the one data request processing device.

5. The method of providing diagnostic information for a data request in a distributed data system including a plurality of interconnected data request processing devices of claim 2, further comprising the step of each data request processing device of the plurality of interconnected data request processing devices that forms a connection between another data request processing device of the plurality of interconnected data request processing devices while processing the data request appending connection information diagnostics to the fulfilled data request related to the connection between the data request processing device and the another data request processing device.

6. The method of providing diagnostic information for a data request in a distributed data system including a plurality of interconnected data request processing devices of claim 1, further comprising the steps of:
c) one data request processing device of the plurality of interconnected data request processing devices appending a data request processing device condition information diagnostics array to the data request; and
d) the one data request processing device of the plurality of interconnected data request processing devices appending a data request processing device connection information diagnostics array to the data request.

7. The method of providing diagnostic information for a data request in a distributed data system including a plurality of interconnected data request processing devices of claim 6, further comprising the step of each of the plurality of interconnected data request processing devices that participate in the processing of the data request inserting data request processing device condition information diagnostics into a row of the condition information diagnostics array.

8. The method of providing diagnostic information for a data request in a distributed data system including a plurality of interconnected data request processing devices of claim 6, further comprising the steps of:
e) another data request processing device of the plurality of interconnected data request processing devices forwarding the data request to the one data request processing device; and
f) the another data request processing device inserting data request processing device condition information diagnostics into a row of the condition information diagnostics array for the another data request processing device.

9. The method of providing diagnostic information for a data request in a distributed data system including a plurality of interconnected data request processing devices of claim 8, further comprising the steps of:
g) the another data request processing device of the plurality of interconnected data request processing devices receiving the fulfilled data request from the one data request processing device; and
h) the another data request processing device inserting connection information diagnostics into a row of the connection information diagnostics array, the connection information diagnostics related to the connection between the another data request processing device and the one data request processing device.

10. The method of providing diagnostic information for a data request in a distributed data system including a plurality of interconnected data request processing devices of claim 7, further comprising the step of each data request processing device of the plurality of interconnected data request processing devices that forms a connection between another data request processing device of the plurality of interconnected data request processing devices while processing the data request inserting connection information diagnostics into a row of the connection information diagnostics array, the connection information diagnostics related to the connection between the data request processing device and the another data request processing device.

11. The method of providing diagnostic information for a data request in a distributed data system including a plurality of interconnected data request processing devices of claim 10, wherein one of the plurality of interconnected data request processing devices is a database server.

12. The method of providing diagnostic information for a data request in a distributed data system including a plurality of interconnected data request processing devices of claim 11, wherein the data request is a SQL request.

13. A computer readable medium encoded with data instruction for providing diagnostic information for a data request in a distributed data system including a plurality of interconnected data request processing devices, such that when executed by the plurality of interconnected data request processing devices, the devices are caused to perform processes comprising:
a) a one data request processing device of the plurality of interconnected data request processing devices fulfilling the data request; and
b) only the one data request processing device of the plurality of interconnected data request processing devices appending request fulfillment diagnostic information to the fulfilled data request.

14. The computer readable medium encoded with data instruction for providing diagnostic information for a data request in a distributed data system including a plurality of interconnected data request processing devices of claim 13, further comprising each of the plurality of interconnected data request processing devices that participate in the processing of the data request appending data request processing device condition information diagnostics to the data request.

15. The computer readable medium encoded with data instruction for providing diagnostic information for a data request in a distributed data system including a plurality of interconnected data request processing devices of claim 13, further comprising:
c) another data request processing device of the plurality of interconnected data request processing devices forwarding the data request to the one data request processing device; and
d) the another data request processing device appending data request processing device condition information diagnostics to the data request.

16. The computer readable medium encoded with data instruction for providing diagnostic information for a data request in a distributed data system including a plurality of interconnected data request processing devices of claim 15, further comprising:
e) the another data request processing device of the plurality of interconnected data request processing devices receiving the fulfilled data request from the one data request processing device; and
f) the another data request processing device appending connection information diagnostics to the fulfilled data request related to the connection between the another data request processing device and the one data request processing device.

17. The computer readable medium encoded with data instruction for providing diagnostic information for a data request in a distributed data system including a plurality of interconnected data request processing devices of claim 14, further comprising each data request processing device of the plurality of interconnected data request processing devices that forms a connection between another data request processing device of the plurality of interconnected data request processing devices while processing the data request appending connection information diagnostics to the fulfilled data request related to the connection between the data request processing device and the another data request processing device.

18. The computer readable medium encoded with data instruction for providing diagnostic information for a data request in a distributed data system including a plurality of interconnected data request processing devices of claim 13, further comprising:
c) one data request processing device of the plurality of interconnected data request processing devices appending a data request processing device condition information diagnostics array to the data request; and
d) the one data request processing device of the plurality of interconnected data request processing devices appending a data request processing device connection information diagnostics array to the data request.

19. The computer readable medium encoded with data instruction for providing diagnostic information for a data request in a distributed data system including a plurality of interconnected data request processing devices of claim 18, further comprising each of the plurality of interconnected data request processing devices that participate in the processing of the data request inserting data request processing device condition information diagnostics into a row of the condition information diagnostics array.

20. The computer readable medium encoded with data instruction for providing diagnostic information for a data request in a distributed data system including a plurality of interconnected data request processing devices of claim 18, further comprising:
e) another data request processing device of the plurality of interconnected data request processing devices forwarding the data request to the one data request processing device; and
f) the another data request processing device inserting data request processing device condition information diagnostics into a row of the condition information diagnostics array for the another data request processing device.

21. The computer readable medium encoded with data instruction for providing diagnostic information for a data request in a distributed data system including a plurality of interconnected data request processing devices of claim 20, further comprising:
g) the another data request processing device of the plurality of interconnected data request processing devices receiving the fulfilled data request from the one data request processing device; and
h) the another data request processing device inserting connection information diagnostics into a row of the connection information diagnostics array, the connection information diagnostics related to the connection between the another data request processing device and the one data request processing device.

22. The computer readable medium encoded with data instruction for providing diagnostic information for a data request in a distributed data system including a plurality of interconnected data request processing devices of claim 19, further comprising each data request processing device of the plurality of interconnected data request processing devices that forms a connection between another data request processing device of the plurality of interconnected data request processing devices while processing the data request inserting connection information diagnostics into a row of the connection information diagnostics array, the connection information diagnostics related to the connection between the data request processing device and the another data request processing device.

23. The computer readable medium encoded with data instruction for providing diagnostic information for a data request in a distributed data system including a plurality of interconnected data request processing devices of claim 22, wherein one of the plurality of interconnected data request processing devices is one of a database server and a gateway.

24. A distributed data system, the system providing diagnostic information for a data request and comprising:
a) a plurality of interconnected data request processing devices; and
b) means for a one data request processing device of the plurality of interconnected data request processing devices to fulfill the data request; and
c) means for only the one data request processing device of the plurality of interconnected data request processing devices to append request fulfillment diagnostic information to the fulfilled data request.

25. The distributed data system of claim 24, further comprising means for each of the plurality of interconnected data request processing devices that participate in the processing of the data request to append data request processing device condition information diagnostics to the data request.

26. The distributed data system of claim 24, further comprising:
d) means for another data request processing device of the plurality of interconnected data request processing devices forwarding the data request to the one data request processing device; and
e) means for the another data request processing device appending data request processing device condition information diagnostics to the data request.

27. The distributed data system of claim 26, further comprising:
f) means for the another data request processing device of the plurality of interconnected data request processing devices receiving the fulfilled data request from the one data request processing device; and
g) means for the another data request processing device appending connection information diagnostics to the fulfilled data request related to the connection between the another data request processing device and the one data request processing device.

28. The distributed data system of claim 25, further comprising means for each data request processing device of the plurality of interconnected data request processing devices that forms a connection between another data request processing device of the plurality of interconnected data request processing devices while processing the data request appending connection information diagnostics to the fulfilled data request related to the connection between the data request processing device and the another data request processing device.

29. The distributed data system of claim 24, further comprising:
c) means for one data request processing device of the plurality of interconnected data request processing devices appending a data request processing device condition information diagnostics array to the data request;
d) means for the one data request processing device of the plurality of interconnected data request processing devices appending a data request processing device connection information diagnostics array to the data request; and
e) means for each of the plurality of interconnected data request processing devices that participate in the processing of the data request inserting data request processing device condition information diagnostics into a row of the condition information diagnostics array.

30. The distributed data system of claim 29, further comprising:
f) means for another data request processing device of the plurality of interconnected data request processing devices forwarding the data request to the one data request processing device;
g) means for the another data request processing device of the plurality of interconnected data request processing devices receiving the fulfilled data request from the one data request processing device; and
h) means for the another data request processing device inserting connection information diagnostics into a row of the connection information diagnostics array, the connection information diagnostics related to the connection between the another data request processing device and the one data request processing device.
